(19) United States
(12) Patent Application Publication
(10) Pub. No.: US 2012/0206347 A1
(43) Pub. Date: Aug. 16, 2012

(54) IMAGE-CAPTURING DEVICE FOR OPTICAL POINTING APPARATUS AND METHOD THEREOF

(75) Inventors: Chun Wei CHEN, Hsinchu (TW); Hsin Chia Chen, Hsinchu (TW); Yao Hsuan Lin, Hsinchu (TW)

(73) Assignee: Pixart Imaging Inc., Hsinchu (TW)

(21) Appl. No.: 13/368,933

(22) Filed: Feb. 8, 2012

(30) Foreign Application Priority Data
Feb. 11, 2011 (TW) 100104530

(51) Int. Cl. G09G 5/08

(52) U.S. Cl. 345/157

(57) ABSTRACT

A method of smoothing the movement of a cursor controlled by an optical pointing apparatus includes the steps of sensing an image of a surface and generating a sensing signal by an optical pointing apparatus, continuously outputting a movement signal to control the movement of a cursor on a display by the sensing signal, and smoothing the continuously outputted movement signal at different levels according to the speed represented by the movement signal.

### CROSS-REFERENCE TO RELATED APPLICATION

The present application is based on, and claims priority from, Taiwan Patent Application Ser. No. 100104530, filed on Feb. 11, 2011, the disclosure of which is hereby incorporated by reference herein in its entirety.

### BACKGROUND

1. Technical Field

The present invention relates to an optical pointing apparatus, and relates more particularly to an image-capturing device for an optical pointing apparatus and a method thereof.

2. Related Art

Pointing apparatuses such as an electronic mouse are devices that can detect their displacements relative to their supporting surfaces. A user grasps a pointing apparatus and slides the pointing apparatus on a planar surface. The pointing apparatus may compute its displacement relative to the planar surface, and may use the displacement as an input signal sent to a computer. A conventional pointing apparatus may compute its displacement according to the number of rolling cycles counted by the roller on the apparatus as the device rolls on a surface. However, accumulated dust may adversely affect the accuracy of the calculation of the displacement of the roller pointing apparatus after the roller pointing apparatus has been used for a long time. Due to such disadvantage, with the development of technology, optical pointing apparatuses such as the optical mouse increasingly replace such roller pointing apparatuses.

Optical pointing apparatuses similarly detect their displacements relative to their supporting surfaces. Unlike conventional roller pointing apparatuses, optical pointing apparatuses detect their displacements based on reflective light. FIG. 1 shows a conventional optical pointing apparatus. As shown in FIG. 1, the optical pointing apparatus 100 comprises a light source 102, a focus lens 104, a light extraction lens 106, a sensing device 108, and a processing unit 110. The light source 102 may be an LED (light-emitting diode) based light source or a laser, which projects light through the focus lens 104 onto a planar surface 150. The planar surface 150 reflects the light, and the light extraction lens 106 collects reflective light and brings it to the sensing device 108. The processing unit 110 uses output signals from the sensing device 108 to calculate the displacement of the optical pointing apparatus 100 relative to the planar surface 150.

FIG. 2 shows an enlarged sensing device 108. As illustrated in FIG. 2, the sensing device 108 comprises a plurality of image-sensing elements 200 arranged in an array. The image-sensing elements 200 may capture the image of the planar surface 150 whereby the output signals are generated. The processing unit 110 compares the correlation between two successive images, and determines the displacement of the optical pointing apparatus 100 relative to the planar surface 150 by the relative orientation and distance between two highly correlated regions. For example, if the comparison result from the processing unit 110 shows that the second image is highly correlated with the upper left region of the first image, it can be determined that the optical pointing apparatus 100 moves in the lower right direction.

Generally, optical pointing apparatuses having image-sensing elements with a fixed dimension have a fixed count per inch (“CPI”) resolution. If an application needs high CPI resolution, for example greater than that provided by the optical pointing apparatus, a linearly proportional magnification method is needed. However, any non-linear effect of the optical pointing apparatus may also be scaled up. Although the optical pointing apparatus may apply a smoothing mechanism to smooth the non-linear effect, the controllability of the optical pointing apparatus is compromised, creating a substandard user experience.

Thus, the relevant industry needs a new optical pointing apparatus.

### SUMMARY

Embodiments provide an image-capturing device for an optical pointing apparatus and a method thereof. The image-capturing device is adaptable to different application environments. In a high CPI resolution application, the image-capturing device can avoid non-linear effects, and in a non-high CPI resolution application, the image-capturing device can achieve better controllability.

One embodiment discloses an image-capturing device for an optical pointing apparatus. The image-capturing device comprises a plurality of image-sensing units, arranged adjacently, and a processing unit. The plurality of image-sensing units are configured to sense an image of a surface and generate a sensing signal that can be used to evaluate the speed of the optical pointing apparatus. The processing unit is configured to continuously output a movement signal to control the movement of a cursor on a display by the sensing signal, and to smooth the continuously outputted movement signal at different levels according to a speed represented by the movement signal.

Another embodiment discloses a method of smoothing the movement of a cursor controlled by an optical pointing apparatus, wherein the method includes the steps of sensing an image of a surface and generating a sensing signal by an optical pointing apparatus, continuously outputting a movement signal to control the movement of a cursor on a display by the sensing signal, and smoothing the continuously outputted movement signal at different levels according to the speed represented by the movement signal.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 shows a conventional optical pointing apparatus;

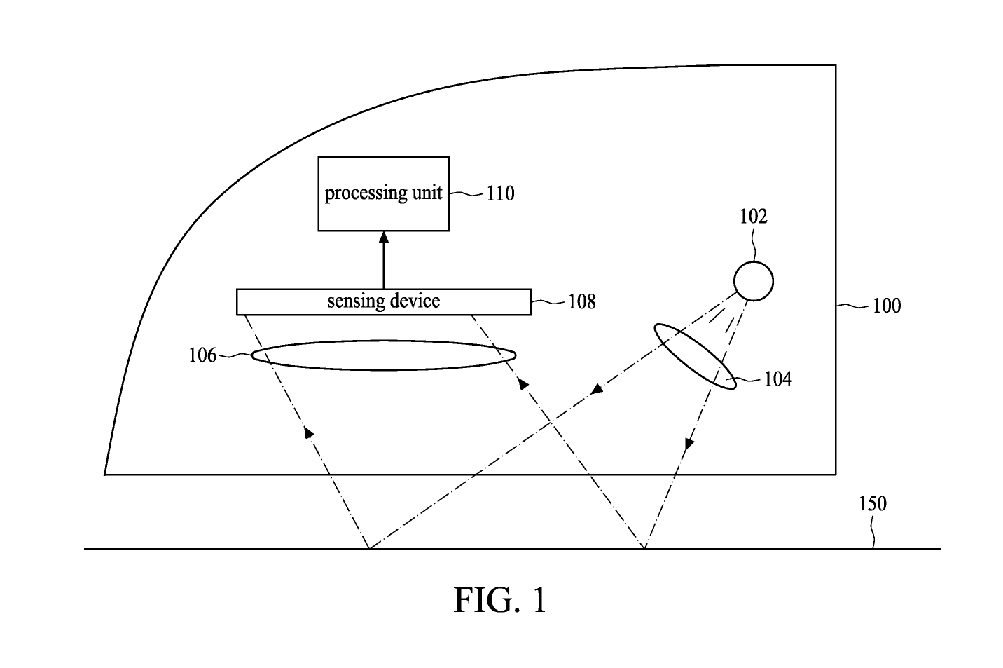

FIG. 2 shows an enlarged sensing device;

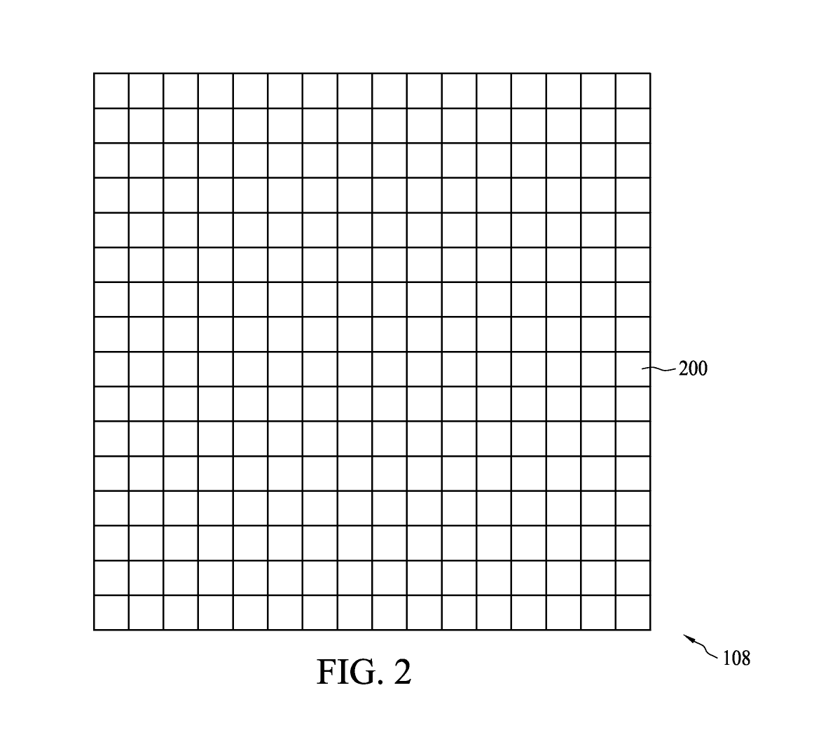

FIG. 3 is a schematic view showing an image-capturing device for an optical pointing apparatus according one embodiment of the present invention;

FIG. 4 is a flow chart showing the steps of a method of smoothing cursor movement controlled by an optical pointing apparatus according to one embodiment of the present invention;

FIG. 5 is a flow chart showing the steps of a method of smoothing cursor movement controlled by an optical pointing apparatus according to another embodiment of the present invention;

FIG. 6 schematically shows impulse responses of an IIR filter and a function thereof; and

FIG. 7 schematically shows impulse responses of an FIR filter and a function thereof.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

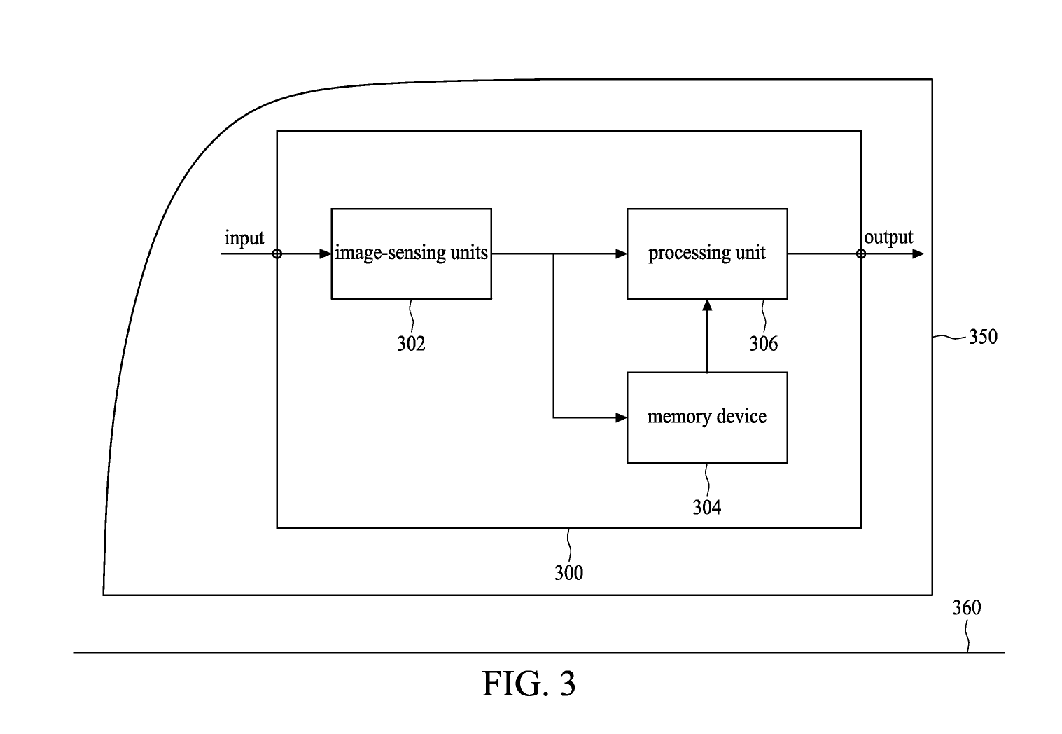

FIG. 3 is a schematic view showing an image-capturing device for an optical pointing apparatus according one embodiment of the present invention. As shown in FIG. 3, the image-capturing device 300 is configured to be installed in an optical pointing apparatus 350 and comprises a plurality of image-sensing units 302 arranged adjacently, a memory device 304, and a processing unit 306. The optical pointing apparatus 350 can slide relative to a planar surface 360. The image-sensing units 302 are configured to sense an image of a surface and generate a sensing signal that can be used to evaluate the speed of the optical pointing apparatus 350. The memory device 304 is configured to store the sensing signal generated by the image-sensing units 302. The processing unit 306 is configured to compare the sensing signal stored in the memory device 304 with the sensing signal generated by the image-sensing units 302 to compute the distance over which the optical pointing apparatus 350 moves. In addition, the processing unit 306 can continuously output a movement signal to control the movement of a cursor on a display by the sensing signal, and smooth the continuously outputted movement signal at different levels according to the speed represented by the movement signal. In the present embodiment, smoothing the continuously outputted movement signal at different levels indicates different smoothing levels applied to the continuously outputted movement signal.

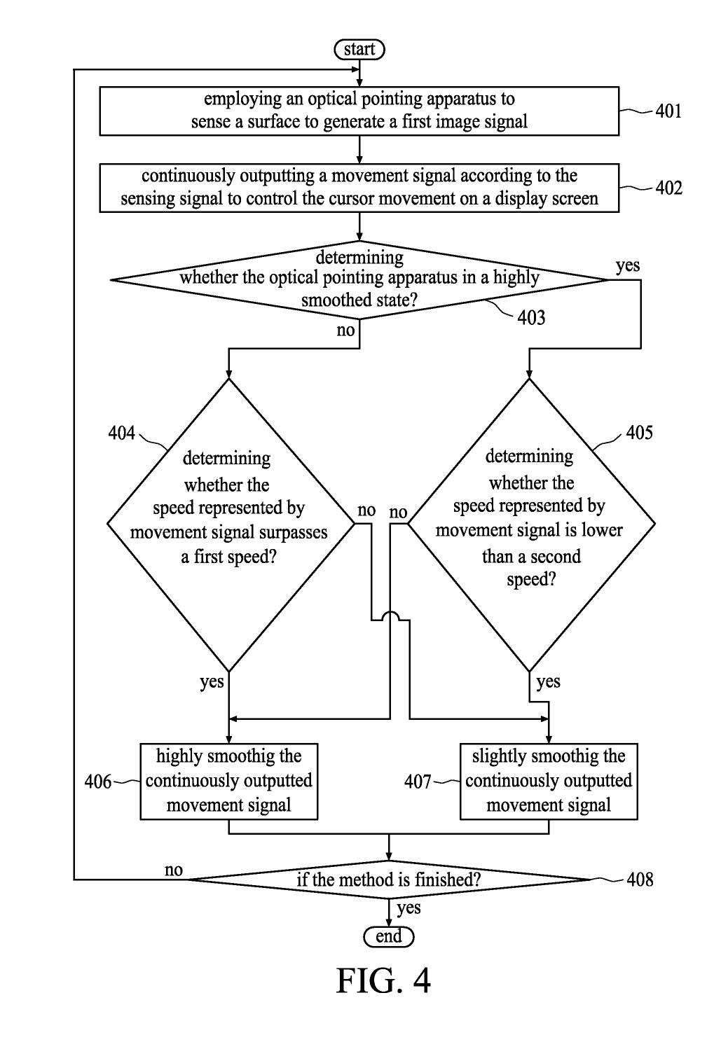

FIG. 4 is a flow chart showing the steps of a method of smoothing cursor movement controlled by an optical pointing apparatus according to one embodiment of the present invention, wherein the method can be applied to the processing unit 306. In Step 401, an optical pointing apparatus is employed to sense an image of a surface to generate a sensing signal, and the method proceeds to Step 402. In Step 402, a movement signal is continuously outputted according to the sensing signal to control the cursor movement on a display screen, and the method continues to Step 403. In Step 403, it is determined whether the optical pointing apparatus is in a greatly smoothed state. If yes, the method proceeds to Step 405; otherwise, the method proceeds to Step 404. In Step 404, it is determined whether the speed represented by the movement signal is greater than a first speed. If yes, the method proceeds to Step 406; otherwise the method proceeds to Step 407. In Step 405, it is determined whether the speed represented by movement signal is lower than a second speed that is not greater than the first speed. If yes, the method proceeds to Step 407; otherwise the method proceeds to Step 406. In Step 406, the continuously outputted movement signal is greatly smoothed, and the method proceeds to Step 408. In Step 407, the continuously outputted movement signal is slightly smoothed, and the method proceeds to Step 408. In Step 408, it is determined whether the method is finished. If yes, the method is terminated; otherwise the method returns to Step 401.

In some embodiments of the present invention, in Step 404, the processing unit 306 calculates the horizontal and vertical displacements of the optical pointing apparatus 350 according to the sensing signal. When the calculated horizontal displacement is greater than a first horizontal threshold or the calculated vertical displacement is greater than a first vertical threshold, the processing unit 306 determines accordingly that the speed represented by the movement signal is greater than the first speed. In Step 405, the processing unit 306 calculates the horizontal and vertical displacements of the optical pointing apparatus 350 according to the sensing signal. When the calculated horizontal displacement is less than a second horizontal threshold and the calculated vertical displacement is less than a second vertical threshold, the processing unit 306 determines that the speed represented by the movement signal is lower than the second speed.

According to the method embodiment shown in FIG. 4, when the outputted movement signal exceeds a predetermined threshold, the processing unit 306 smooths the continuously outputted movement signal. In particular, when the speed represented by the movement signal exceeds the first speed, the processing unit 306 greatly smoothes the continuously outputted movement signal. When the speed represented by the movement signal is slower than the second speed, the processing unit 306 slightly smoothes the continuously outputted movement signal. In real applications, if a user moves the optical pointing apparatus 350 at a high speed, or in other words, if the speed represented by the movement signal outputted from the optical pointing apparatus 350 is higher than the first speed, the optical pointing apparatus 350 covers a broader range. At such moment, a linear magnification technique can be applied to achieve high CPI resolution. At the same time, the processing unit 306 accordingly greatly smoothes the continuously outputted movement signal to achieve a smoothing effect. Because the user moves the optical pointing apparatus 350 fast at such moment, the user will not easily discern the pull and drag action effect caused by the smoothing operation. If the user moves the optical pointing apparatus 350 at a low speed, or in other words, if the speed represented by the movement signal outputted from the optical pointing apparatus 350 is lower than the second speed, the optical pointing apparatus 350 covers a smaller range. At such moment, the optical pointing apparatus 350 may slightly smooth the continuously outputted movement signal so as to reduce the pull and drag action effect caused by the smoothing operation, creating a better user experience.

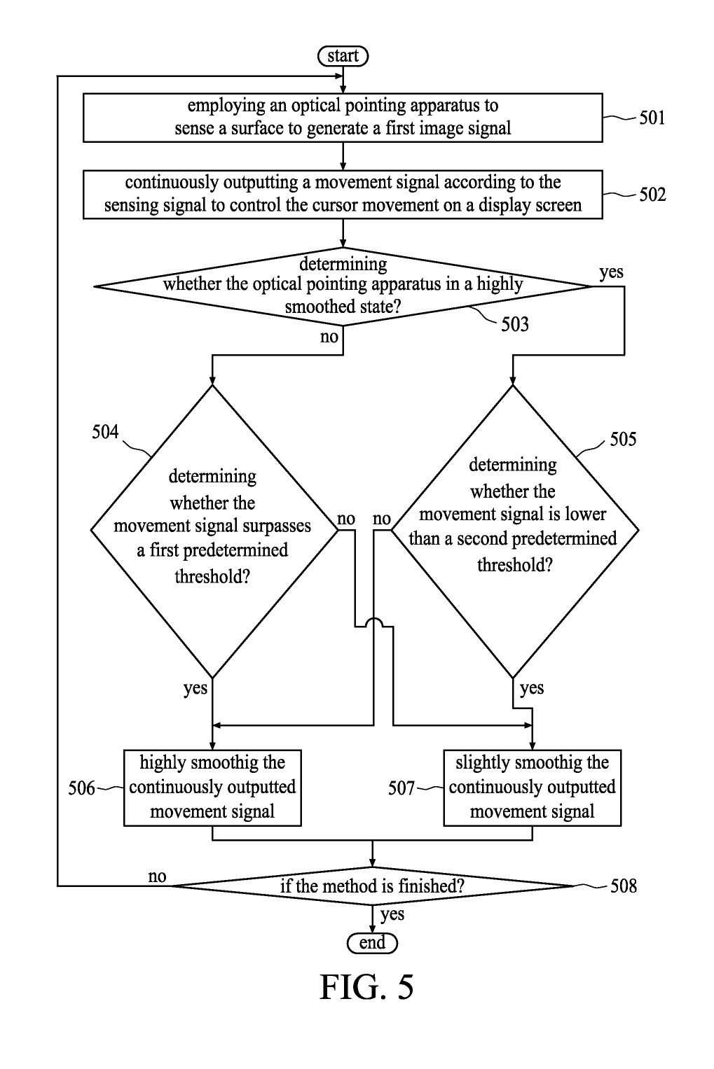

FIG. 5 is a flow chart showing the steps of a method of smoothing cursor movement controlled by an optical pointing apparatus according to another embodiment of the present invention, wherein the method can be applied to the processing unit 306. In Step 501, an optical pointing apparatus is employed to sense an image of a surface to generate a sensing signal, and the method proceeds to Step 502. In Step 502, a movement signal is continuously outputted according to the sensing signal to control the cursor movement on a display screen, and the method continues to Step 503. In Step 503, it is determined whether the optical pointing apparatus is in a greatly smoothed state. If yes, the method proceeds to Step 505; otherwise, the method proceeds to Step 504. In Step 504, it is determined whether the movement signal exceeds a first predetermined threshold. If yes, the method proceeds to Step 506; otherwise the method proceeds to Step 507. In Step 505, it is determined whether the movement signal is lower than a second predetermined threshold that is not greater than the first predetermined threshold. If yes, the method proceeds to Step 507; otherwise the method proceeds to Step 506. In Step 506, the continuously outputted movement signal is greatly smoothed, and the method proceeds to Step 508. In Step 507, the continuously outputted movement signal is slightly smoothed, and the method proceeds to Step 508. In Step 508, it is determined whether the method is finished. If yes, the method is terminated; otherwise the method returns to Step 501.

In some embodiments of the present invention, in Step 504, the processing unit 306 calculates the horizontal and vertical displacements of the optical pointing apparatus 350 according to the sensing signal. When the calculated horizontal displacement is greater than a first horizontal threshold or the calculated vertical displacement is greater than a first vertical threshold, the processing unit 306 determines accordingly that the movement signal exceeds the first predetermined threshold. In Step 505, the processing unit 306 calculates the horizontal and vertical displacements of the optical pointing apparatus 350 according to the sensing signal. When the calculated horizontal displacement is less than a second horizontal threshold and the calculated vertical displacement is less than a second vertical threshold, the processing unit 306 determines that the movement signal is lower than the second predetermined threshold.

According to the method embodiment shown in FIG. 5, when the outputted movement signal exceeds a predetermined threshold, the processing unit 306 smooths the continuously outputted movement signal. In particular, when the movement signal is greater than the first predetermined threshold, the processing unit 306 greatly smoothes the continuously outputted movement signal. When the movement signal is smaller than the second predetermined threshold, the processing unit 306 slightly smoothes the continuously outputted movement signal. Similar to the method demonstrated in FIG. 4, the method illustrated in FIG. 5 may be applied by the optical pointing apparatus 350 to allow the optical pointing apparatus 350 to use a linear magnification technique to achieve high CPI resolution and to greatly smooth the continuously outputted movement signal. In contrast, when a user emphasizes controllability, the continuously outputted movement signal is slightly smoothed.

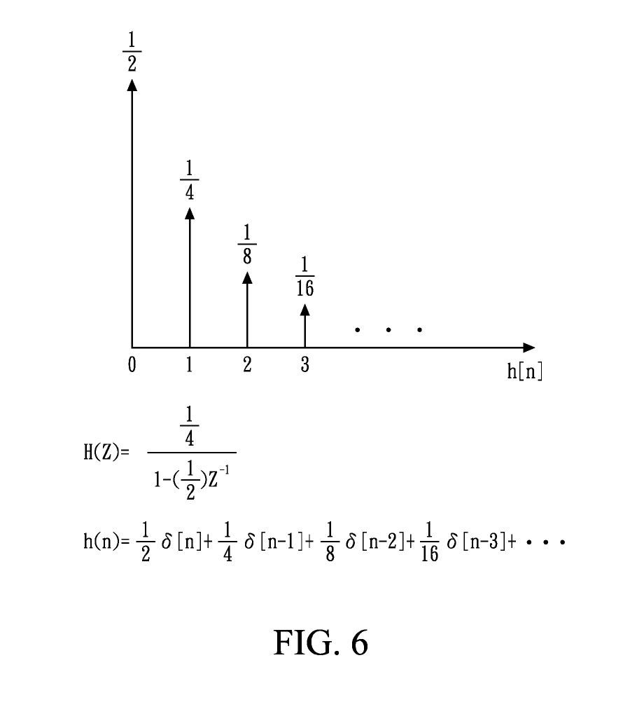

In some embodiments of the present invention, the greatly smoothing mechanism is realized according to an infinite impulse response (IIR) filter algorithm. In some embodiments of the present invention, the optical pointing apparatus 350 further comprises an IIR filter circuit that is configured to greatly smooth the continuously outputted movement signal. FIG. 6 schematically shows impulse responses of an IIR filter and a function thereof, wherein the IIR filter can be applied to the optical pointing apparatus 350 of the embodiment in FIG. 3.

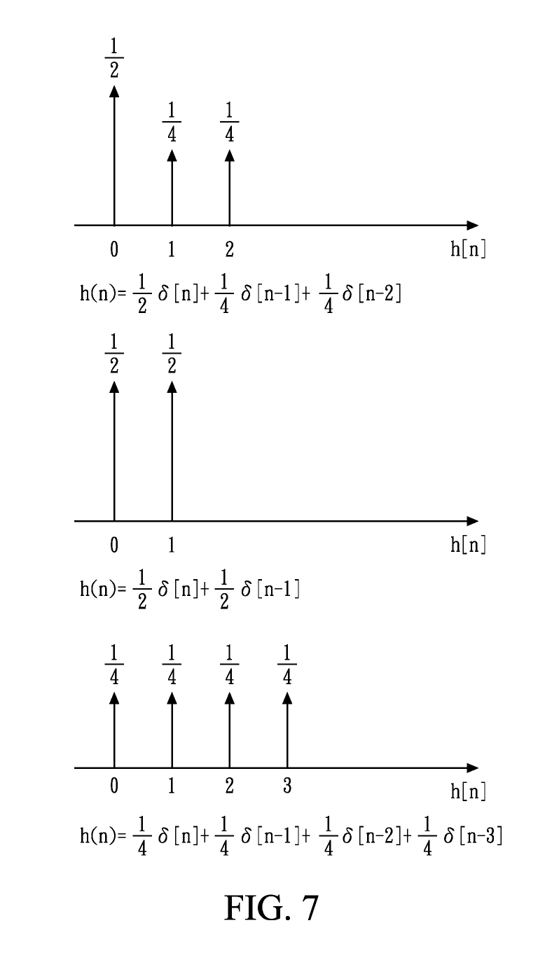

In some embodiments of the present invention, the slightly smoothing mechanism is realized according to a finite impulse response (FIR) filter algorithm. In some embodiments of the present invention, the optical pointing apparatus 350 may further comprise an FIR filter circuit that is configured to slightly smooth the continuously outputted movement signal. FIG. 7 schematically shows impulse responses of an FIR filter and a function thereof, wherein the FIR filter can be applied to the optical pointing apparatus 350 of the embodiment in FIG. 3.

In summary, the image-capturing device for an optical pointing apparatus and a method thereof in some embodiments of the present invention can be adjustable to different application environments. In a high CPI resolution application, the continuously outputted movement signal is greatly smoothed so that non-linear effects can be avoided, and in a non-high CPI resolution application, the continuously outputted movement signal is slightly smoothed so that better controllability can be achieved.

It will be apparent to those skilled in the art that various modifications and variations can be made to the disclosed embodiments. It is intended that the specification and examples be considered as exemplary only, with a true scope of the disclosure being indicated by the following claims and their equivalent.

What is claimed is:

1. A image-capturing device for an optical pointing apparatus, comprising:
a plurality of image-sensing units arranged adjacently, configured to sense an image of a surface and generate a sensing signal that can be used to evaluate the speed of movement of the optical pointing apparatus; and
a processing unit configured to continuously output a movement signal to control movement of a cursor on a display by the sensing signal, and to smooth the continuously outputted movement signal at different levels according to a speed represented by the movement signal.

2. The image-capturing device of claim 1, wherein the processing unit is configured to greatly smooth the continuously outputted movement signal when the speed represented by the movement signal exceeds a first speed, and to slightly smooth the continuously outputted movement signal when the speed represented by the movement signal is slower than a second speed.

3. The image-capturing device of claim 2, wherein the processing unit is configured to calculate horizontal and vertical displacements of the optical pointing apparatus according to the sensing signal, and when the horizontal displacement is greater than a first horizontal threshold or the vertical displacement is greater than a first vertical threshold, the processing unit determines that the speed represented by the movement signal exceeds the first speed, and when the horizontal displacement is less than a second horizontal threshold and the vertical displacement is less than a second vertical threshold, the processing unit determines that the speed represented by the movement signal is lower than the second speed.

4. The image-capturing device of claim 2, wherein the processing unit greatly smoothes the continuously outputted movement signal according to an infinite impulse response filter algorithm.

5. The image-capturing device of claim 2, further comprising an infinite impulse response filter circuit configured to greatly smooth the continuously outputted movement signal.

6. The image-capturing device of claim 2, wherein the processing unit slightly smoothes the continuously outputted movement signal according to a finite impulse response filter algorithm.

7. The image-capturing device of claim 2, further comprising a finite impulse response filter circuit configured to slightly smooth the continuously outputted movement signal.

8. The image-capturing device of claim 1, wherein the processing unit is configured to smooth the continuously outputted movement signal when the movement signal exceeds a first predetermined threshold, and the processing unit slightly smoothes the continuously outputted movement signal when the movement signal is smaller than a second predetermined threshold, wherein the first predetermined threshold is greater than the second predetermined threshold.

9. The image-capturing device of claim 8, wherein the processing unit is configured to calculate horizontal and vertical displacements of the optical pointing apparatus according to the sensing signal, and the processing unit determines that the movement signal exceeds the first predetermined threshold when the horizontal displacement is greater than a first horizontal threshold or the vertical displacement is greater than a first vertical threshold, and the processing unit determines that the movement signal is lower than the second predetermined threshold when the horizontal displacement is less than a second horizontal threshold and the vertical displacement is less than a second vertical threshold.

10. The image-capturing device of claim 8, wherein the processing unit greatly smoothes the continuously outputted movement signal according to an infinite impulse response filter algorithm.

11. The image-capturing device of claim 8, further comprising an infinite impulse response filter circuit configured to greatly smooth the continuously outputted movement signal.

12. The image-capturing device of claim 8, wherein the processing unit slightly smoothes the continuously outputted movement signal according to a finite impulse response filter algorithm.

13. The image-capturing device of claim 8, further comprising a finite impulse response filter circuit configured to slightly smooth the continuously outputted movement signal.

14. The image-capturing device of claim 1, further comprising a memory device configured to store the sensing signal generated by the image-sensing units.

15. A method of smoothing cursor movement controlled by an optical pointing apparatus, comprising the steps of:
employing an optical pointing apparatus to sense an image of a surface and generating a sensing signal;
continuously outputting a movement signal to control movement of a cursor on a display by the sensing signal; and
smoothing the continuously outputted movement signal at different levels according to a speed represented by the movement signal.

16. The method of claim 15, wherein the step of smoothing the continuously outputted movement signal comprises the steps of:
greatly smoothing the continuously outputted movement signal when the speed represented by the movement signal exceeds a first speed; and
slightly smoothing the continuously outputted movement signal when the speed represented by the movement signal is lower than a second speed;
wherein the first speed is greater than the second speed.

17. The method of claim 16, wherein the step of greatly smoothing is performed according to an infinite impulse response filter algorithm.

18. The method of claim 16, wherein the step of slightly smoothing is performed according to a finite impulse response filter algorithm.

19. The method of claim 15, wherein the step of smoothing the continuously outputted movement signal comprises the steps of:
greatly smoothing the continuously outputted movement signal when the movement signal exceeds a first predetermined threshold; and
slightly smoothing the continuously outputted movement signal when the movement signal is lower than a second predetermined threshold;
wherein the first predetermined threshold is greater than the second predetermined threshold.

20. The method of claim 19, wherein the step of greatly smoothing is performed according to an infinite impulse response filter algorithm.

21. The method of claim 19, wherein the step of slightly smoothing is performed according to a finite impulse response filter algorithm.
